(19) United States
(12) Patent Application Publication
(10) Pub. No.: US 2025/0178687 A1
(43) Pub. Date: Jun. 5, 2025

(54) BICYCLE TORQUE SENSOR AND CALIBRATION THEREFOR

(71) Applicant: SRAM, LLC, CHICAGO, IL (US)

(72) Inventor: BERNO JOHANNES ENGELBERT MISGELD, NEUSS (DE)

(73) Assignee: SRAM, LLC, CHICAGO, IL (US)

(21) Appl. No.: 18/837,649

(22) PCT Filed: Feb. 17, 2022
(86) PCT No.: PCT/EP2022/053939

§ 371 Date: Aug. 12, 2024

(51) Int. Cl. B62J 45/411; B62J 45/412; B62J 45/421; B62M 6/50; G01L 5/00; G01L 25/00

(52) U.S. Cl. CPC B62J 45/411; B62J 45/412; B62M 6/50; G01L 5/00; G01L 25/003; B62J 45/421

(57) ABSTRACT

Pedelec with an electric drive unit (30) for driving at least one wheel (22) of the pedelec (10), a battery (34) for supplying the drive unit (30) with electrical drive energy, a torque sensor (47) for detecting a rider torque applied to a pedal crankshaft (32) by a rider, and a pedelec controller (50) with a motor control module (52) which controls the assistance power of the drive unit (30) as a function of the rider torque recorded by the torque sensor (47), and a calibration module (54) for calibrating the torque sensor (47), which is configured to start a calibration process when the driven wheel (22) is stopped, the pedal crankshaft (32) is stopped, and an average deviation (Ao, Au), referred to a mean value (M), of the torque signal (T) of the torque sensor (47) is below a predefined maximum value (Mo, Mu) over a predefined time period (t).

The invention relates to a pedelec and a method for calibrating a torque sensor for recording a rider torque introduced into a pedal crankshaft of a pedelec.

Such pedelecs are generally known bicycles with an electric drive unit for driving assistance. The electric drive unit drives one of the two wheels of the pedelec, so that the pedelec is driven by a rider power introduced into a pedal crankshaft by the rider and by the assistance power generated by the electric drive unit depending on the rider power or rider torque.

A torque sensor, in particular a non-contact torque sensor, is provided for determining the rider torque or rider power and for determining the assistance power generated by the electric drive unit as a function of the rider torque or rider power. The torque sensor is usually arranged on the pedal crankshaft and detects the rider torque introduced into the pedal crankshaft by the rider by recording the torsion of the pedal crankshaft. Otherwise, the torque sensor can also be arranged on another component loaded by the rider torque.

The problem with the used torque sensors is that they can be afflicted with an error in the zero point shift, also known as offset error. An error of this type directly influences the assistance power, for example a reduction in the assistance power, since the detected rider torque is falsified by the zero offset and the assistance power depends on the rider torque recorded by the torque sensor. Such an error results in particular from static, mechanical stresses, which are temperature-related, for example.

To avoid the error in the zero point shift, the torque sensor is usually calibrated during the manufacture of the pedelec, i.e. in particular during the assembly of the pedelec or the electric drive unit. The problem is that the error in the zero point shift can also occur only during riding operation or only after the pedelec has been used. If the error occurs, the control of the pedelec in subsequent operation of the pedelec is based on incorrect rider torque values recorded by the torque sensor.

Against this background, the task of the invention is to create a pedelec in which the accuracy of the recording of the rider torque can be improved in a simple and reliable manner, thereby improving the operation of the pedelec.

This problem is solved by a pedelec with the features of the main claim.

The pedelec according to the invention comprises an electric drive unit which is used to drive at least one of the two wheels of the pedelec. The electric drive unit can be connected directly or indirectly to the wheel to be driven in a torque-transmitting manner. The pedelec further comprises a battery, i.e. an accumulator, for operating the drive unit, i.e. for supplying the electric drive unit with electric drive energy, and a pedelec controller. The pedelec control system comprises a motor control module, wherein the motor control module controls the electric drive unit as a function of a rider torque introduced into the pedal crankshaft by the rider. A support function is stored in the motor control module for this purpose. If necessary, the assistance function can be set by the rider in steps between maximum assistance and minimum assistance via a control unit.

In order to measure the rider torque introduced into the pedal crankshaft by the rider, a torque sensor is provided, which is arranged in particular on the pedal crankshaft and records the rider torque acting on the pedal crankshaft by detecting the torsion of the pedal crankshaft.

According to the invention, the pedelec control system additionally comprises a calibration module for calibrating the torque sensor, wherein the calibration is performed in a state of the pedelec in which the rider torque recorded by the torque sensor should be zero. Thus, the zero point of the torque signal is set during calibration, from which the subsequent measurements of the rider torque start. In this way, there is no error in the zero point shift immediately after calibration.

To ensure reliable calibration, several conditions must be met before a calibration process is started. In this way, it can be ensured that the pedal crankshaft is not loaded by the driver during calibration of the torque sensor and that no influences affecting the torque sensor are present. The driven wheel and the crankshaft must be stopped. In addition, an average deviation of the torque signal of the torque sensor related to a mean value must be below a predefined maximum value over a predefined period of time, which can ensure that the pedal crankshaft is actually not loaded by the rider. By using the average deviation, outliers of the torque signal, which would unnecessarily prevent a calibration process, can be ignored.

Once the above conditions are met, a calibration process is performed, which can prevent a zero point shift error occurring after the pedelec is manufactured, i.e., at any time when the pedelec is in use.

The conditions can be applied in riding operation, for example, while waiting at a red light, wherein the rider's feet are on the roadway and not on the pedals. The calibration process takes a few seconds, so due to the short calibration time in riding operation of the pedelec, there are a variety of situations in which the calibration process can be performed.

The maximum value is to be understood in such a way that, starting from the zero point, it can be a lower maximum value in a decreasing range and/or an upper maximum value in an increasing range. In both cases the maximum value for starting the calibration of the torque sensor must not be exceeded, i.e. in particular with the lower maximum value starting from the zero point.

Preferably, the calibration process starts when the absolute torque signal exceeds a predefined minimum value. This is to prevent the calibration process from being carried out even in the event of minor errors in the zero point shift, thereby consuming resources, i.e. memory as well as processor power, unnecessarily, i.e. without any decisive added value. For example, the minimum value can be a few newton meters, in particular 5 Nm. This means that a calibration process is not started when the pedal crankshaft is stopped, the wheel is stationary and the average deviation is below a maximum value, if the value of the torque signal of the torque sensor is below the minimum value.

In a preferred embodiment, the average deviation of the torque signal is the standard deviation or the variance relative to the mean value, wherein the standard deviation and the variance are quantities known from statistics and are directly related to each other. The variance is a measure of dispersion which characterizes the distribution of values around the mean. It is the square of the standard deviation. The variance is calculated by dividing the sum of the squared deviations of all measured values from the arithmetic mean by the number of measured values. Thus, the difference between the dispersion parameter variance and the standard deviation is that the standard deviation measures the average distance from the mean and the variance measures the squared average distance from the mean.

Preferably, a calibration process is performed in such a way that it is first checked whether the driven wheel stops, the treadle shaft stops, and an average deviation of the torque signal of the torque sensor related to a mean value is below a predefined maximum value over a predefined period of time, then information for the calibration is gathered over a period of time and only when, after collecting the information, the driven wheel continues to stop, the pedal crankshaft continues to stop, and the average deviation, based on a mean value, of the torque signal of the torque sensor continues to be below a predefined maximum value over a predefined time period is the calibration of the torque sensor performed. This ensures that no relevant loads on the pedal crankshaft caused by the rider acting on the pedals and thus on the pedal crankshaft are applied even while the information is being collected, which means that the calibration of the torque sensor can be performed reliably and without distortion.

In a preferred embodiment, the zero point of the torque sensor is reset during each calibration, wherein the zero point means that the torque sensor outputs a value equal to zero when the pedal crankshaft is not loaded by the driver.

Preferably, a first rotational speed sensor is provided for recording the rotational speed of the wheel. In particular, the speed sensor is used to determine the driving speed of the pedelec, wherein the determined driving speed is displayed on a driver interface and is used to switch off the assistance provided by the electric drive unit from a predefined driving speed, such as 25 km/h. Thus, an already existing speed sensor is used to determine the standstill of the wheel, so that no cost-intensive, additional components are required to determine the standstill of the wheel.

In a preferred embodiment, the first speed sensor is a high-resolution speed sensor which interacts with a sensor disk with at least ten scanning points, wherein the sensor disk is arranged on the wheel. On the one hand, this allows the driving speed to be determined relatively accurately. On the other hand, the check of the conditions, in particular whether the wheel is stopped, can be determined in a relatively short period of time, since only a few sensing points distributed over a short circular section of the wheel are required for this. A speed sensor commonly used on pedelecs interacts with a single sensing point, which is usually configured as a magnet attached to a spoke of the wheel, wherein multiple revolutions of the wheel and thus a relatively long period of time are required to determine the speed of travel and whether the wheel is stationary.

Preferably, a second speed sensor is provided to record the speed of the pedal crankshaft. This allows a stop of the pedal crankshaft to be reliably detected.

In a preferred embodiment, the calibration module is active during riding operation of the pedelec and the calibration process can be performed during riding operation.

The problem is further solved by a method for calibrating a torque sensor for recording a rider torque introduced into a pedal crankshaft of a pedelec according to claims 1 to 9, wherein
the rotational speed of the driven wheel is determined
the rotational speed of the pedal crankshaft being determined
an average deviation of the torque signal of the torque sensor relative to an average value is calculated, and
the calibration process is started when the rotational speed of the wheel is zero, the rotational speed of the pedal crankshaft is zero and the average deviation of the torque signal is below a predefined maximum value.

For the advantages of the method, reference is made to the preceding paragraphs.

With such a design of the pedelec, the calibration of the torque sensor can be carried out in a simple and reliable manner even during riding operation of the pedelec, so that a zero point shift of the torque signal can be reliably prevented and thus a disadvantageous influence of the electric drive unit on the assistance power dependent on the torque signal can be reliably prevented.

An embodiment of the invention is explained in more detail with reference to the drawings.

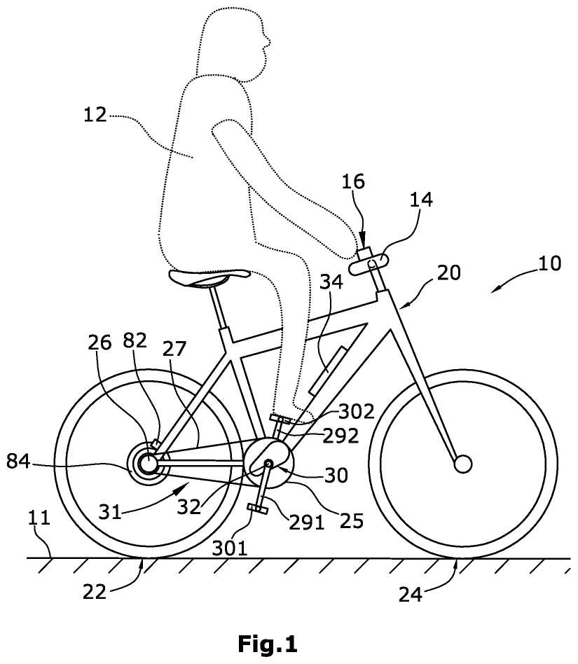

FIG. 1 shows a schematic representation of a pedelec with an electric drive unit for driving a rear wheel,

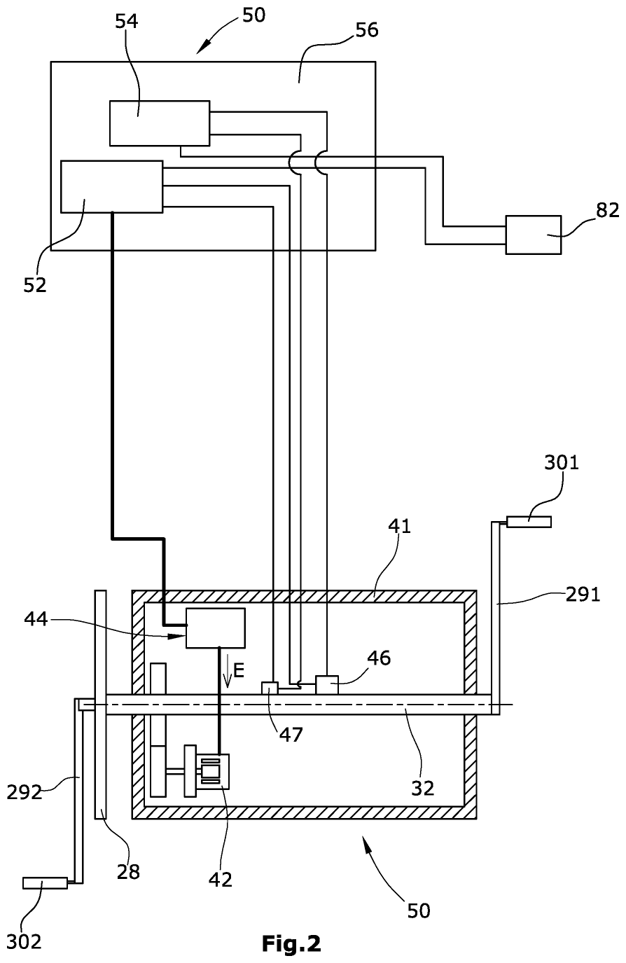

FIG. 2 shows a schematic representation of the electric drive unit from FIG. 1 and a pedelec control system, and

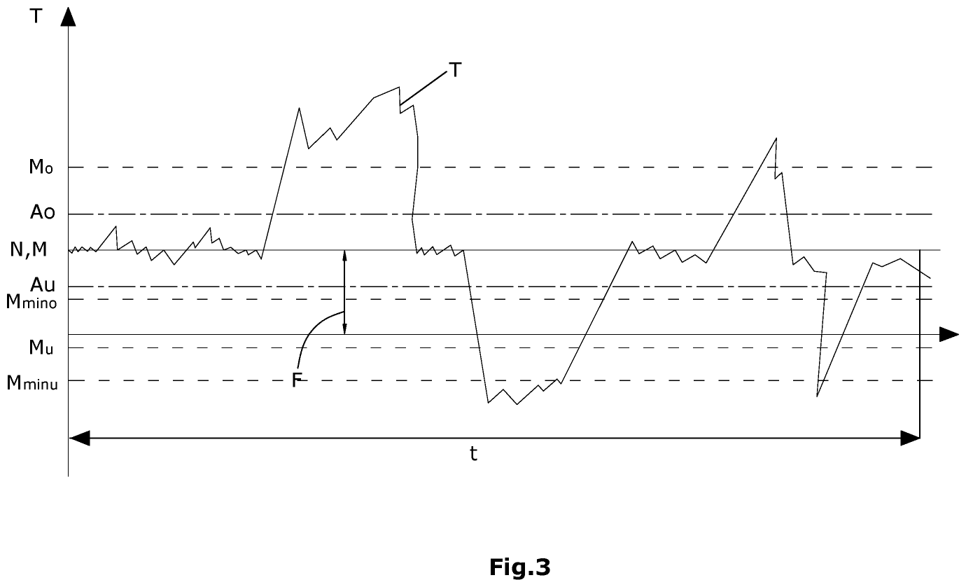

FIG. 3 shows a rider torque-time diagram.

FIG. 1 schematically shows a pedelec 10, which is configured as a pedelec and is ridden by a driver 12 on a roadway 11. The pedelec 10 comprises a pedelec frame 20, a rear wheel 22 and a front wheel 24, wherein the front wheel 24 can be steered via a handlebar 14. Attached to the handlebar 14 is a pedelec control unit 16, which is used for, among other things, setting a level of assistance by the rider 12, displaying a pedelec speed, or the like.

Attached to the pedelec frame 20 are an electric drive unit 30 and a battery 34 for supplying electric power to the electric drive unit 30, wherein the electric drive unit 30 is configured as a mid-motor, also referred to as a bottom bracket motor. The electric drive unit 30 comprises a rotatably mounted pedal crankshaft 32 which comprises a pedal crank 291, 292 at each of its two longitudinal ends, and a pedal 301, 302 is rotatably mounted at each of its free ends. The electric drive unit 30 is torque-transmittingly connected to a pinion cassette 26 attached to the rear wheel 22 via an output chainring 25 and a drive chain 27, whereby mechanical drive power is transmitted from the electric drive unit 30 to the pinion cassette 26.

A first speed sensor 82 is arranged at the rear wheel 22, via which, among other things, the current pedelec speed is recorded, which is transmitted to a pedelec control unit 50. The first speed sensor 82 is configured as a high-resolution sensor and interacts with a sensor disk 84. The sensor disc 84 comprises a plurality of sensing points distributed around the circumference. In particular, the sensor disk 84 may comprise 10, 20, 30, 40, 50 or even 100 sensing points.

FIG. 2 shows the electric drive unit 30 and the pedelec controller 50. The electric drive unit 30 comprises a substantially closed housing 41 in which the pedal crankshaft 32 is rotatably mounted. An electric motor 42 driving the pedal crankshaft 32, a transmission 43, and power electronics 44 providing the electric drive energy for the electric motor 42 in response to corresponding control signals are arranged in the housing 41. Furthermore, a second speed sensor 46 and a torque sensor 47 are arranged in the electric drive unit 30, wherein the torque sensor 47 determines the rider torque T introduced into the pedal crankshaft 32 by the rider 12 and the first speed sensor 46 determines the rider cadence, i.e. the rider speed. The rider power is determined by the signals from the torque sensor 47 and the crankshaft speed sensor 46.

The pedelec controller 50 comprises a motor control module 52 whose output signals directly control the drive motor power electronics 44. The motor control module 52 is signal-connected to the second speed sensor 46, the torque sensor 47, and the first speed sensor 82, wherein a assistance function is stored in the motor control module 52. Based on the assistance function, the amount of assistance provided by the electric drive unit 30 is determined.

The torque sensor 47 comprises a measuring range which is divided into a positive and a negative range, whereby a sinusoidal rider torque extending around a zero point can be recorded.

The pedelec controller 50 also includes a calibration module 54 that is signal-connected to the first speed sensor 82, to the second speed sensor 46, and to the torque sensor 47.

Typically, when the pedelec is manufactured, i.e., in particular, when the pedelec 10 or the electric drive unit 30 is assembled, the torque sensor 47 is calibrated, wherein the torque signal from the torque sensor 47 is corrected for an existing error in zero point shift, i.e., offset. In other words, after calibration, the torque sensor 47 outputs a torque signal equal to zero when there is no load on the pedal crankshaft 32 from the rider 12. Problematically, such an error in the zero point shift can also occur only during riding operation or only after a use of the pedelec 10, wherein the error directly leads to an influence of the assistance power by the electric drive unit 30, for example to a reduced assistance power.

The calibration module 54 is used to calibrate the torque sensor 47 also after a use of the pedelec 10, wherein the calibration is or can be performed in particular during the use of the pedelec 10.

In order to perform a reliable calibration of the torque sensor 47, several conditions must be met. Thereby, the calibration is started only when all conditions are fulfilled. The conditions are checked and the calibration of the torque sensor 47 is performed by the calibration module 54 of the pedelec controller 50.

The first condition is that the wheel 22 is stopped, i.e., the first speed sensor 82 records a speed equal to zero and outputs a corresponding speed signal to the calibration module 54. The second condition is that the pedal crankshaft 32 is stopped, i.e., the second speed sensor 46 records a speed equal to zero and outputs a corresponding speed signal to the calibration module 54. The third condition is that an average deviation of the torque signal of the torque sensor 47 related to an average value, i.e., the variance, is below a predefined maximum value over a predefined period of time. Alternatively, the standard deviation directly related to the variance may be used as the average deviation. The fourth condition is that the absolute torque signal from the torque sensor 47, i.e. the zero point in the case of a non-loaded pedal crankshaft 32, is above a predefined minimum limit. This is intended to prevent calibration of the torque sensor 47 from being performed even in the event of minor errors in the zero point shift, which do not yet lead to any significant negative influence on the operation of the pedelec 10, thereby unnecessarily consuming the capacity of the pedelec controller 50.

FIG. 3 illustrates a diagram showing a torque sensor 47 characteristic with a no-load pedal crankshaft 32. The diagram shown in FIG. 3 is used to explain the third condition.

The diagram includes a solid line N defining a zero point of the torque sensor 47, wherein the actual recorded torque signal T of the torque sensor 47 extends around the line N with certain fluctuations. The zero point N is not located on the x-axis, which would correspond to a value of 0 Nm, but is offset parallel to the x-axis. This results in a so-called error F in the zero point shift. Here, a zero point shift into the positive measuring range of the torque sensor 47 is shown as an example.

The diagram in FIG. 3 also shows an upper maximum value Mo, a lower maximum value Mu, a lower average deviation Au and an upper average deviation Ao as well as an upper minimum value Mmino and a lower minimum value Mminu. Based on the measuring range of the torque sensor 47 being divided into a positive range and a negative range, an upper and a lower maximum value Mo, Mu and an upper and a lower minimum value Mmino, Mminu are defined, respectively. Furthermore, an upper and a lower average deviation Ao, Au, which are related to a mean value M, are determined in each case. The mean value M lies on the line N in the present case.

As can be seen from the diagram, the absolute torque signal T extends above the minimum value Mmino, so that the fourth condition is fulfilled. Furthermore, the average deviations Ao, Au over a predefined time period t do not exceed the maximum values Mo, Mu, so that the third condition is also fulfilled. When the pedal crankshaft 32 and the wheel 22 also stop, a calibration process is started.

During operation of the pedelec 10, the above conditions are repeatedly queried. If all of the conditions are present, calibration of the torque sensor 47 is started, wherein the information required for calibration is first gathered. Subsequently, the conditions are queried again. If all of the conditions are present again, the actual calibration of the torque sensor 47 is performed, wherein the zero point is reset, i.e. shifted to the x-axis. By interrogating the conditions twice, it can be ensured that no load was applied to the pedal crankshaft 32 during the calibration process, for example by the rider 12 stepping on a pedal 301, 302, and thus the calibration could not proceed properly.

The use of the average deviation Ao, Au and not the actual deviation of the torque signal T has the decisive advantage that an outlier extending over the maximum values Mo, Mu can be ignored, wherein such outliers are present relatively often and would unnecessarily prevent a calibration in relatively many cases. FIG. 3 shows four such outliers.

It should be clear that other constructive embodiments of the pedelec 10 compared to the described embodiment are also possible without leaving the scope of protection of the main claim. For example, the rotational speed of the wheel 22 and/or the pedal crankshaft 32 can be determined by calculation.

1-10. (canceled)

11. A pedelec comprising:
an electric drive unit for driving at least one wheel of the pedelec;
a battery for supplying the drive unit with electrical drive energy;
a torque sensor for detecting a rider torque applied to a pedal crankshaft by a rider; and
a pedelec controller having:
a motor control module which controls the assistance power of the drive unit as a function of the rider torque recorded by the torque sensor; and
a calibration module for calibrating the torque sensor configured to start a calibration process when the driven wheel is stopped, the pedal crankshaft is stopped, and an average deviation, related to a mean value, of the torque signal of the torque sensor is below a predefined maximum value over a predefined time period.

12. The pedelec of claim 1, wherein the calibration process starts when the absolute torque signal of the torque sensor exceeds a minimum value.

13. The pedelec of claim 1, wherein the average deviation of the torque signal is a standard deviation or a variance.

14. The pedelec of claim 1, wherein a calibration process checks whether the driven wheel is stopped, the pedal crankshaft is stopped, and an average deviation of the torque signal of the torque sensor related to a mean value is below a predefined maximum value over a predefined period of time, information for calibration is gathered over a period of time, and the calibration of the torque sensor is performed when the driven wheel continues to be stopped, the pedal crankshaft continues to be stopped, and the average deviation, based on a mean value, of the torque signal of the torque sensor continues to be below the predefined maximum value over a predefined time period.

15. The pedelec of claim 1, wherein a zero point is set during each calibration of the torque sensor.

16. The pedelec of claim 1, wherein a first speed sensor is provided for recording the speed of the wheel.

17. The pedelec of claim 1, wherein the first rotational speed sensor is a high-resolution rotational speed sensor that interacts with a sensor disc having at least ten sensing points, wherein the sensor disc is arranged on the wheel.

18. The pedelec of claim 1, wherein a second speed sensor is provided for recording the speed of the pedal crankshaft.

19. The pedelec of claim 1, wherein the calibration module is active during riding operation of the pedelec and the calibration process can be performed during riding operation.

20. A method of calibrating a torque sensor for recording a rider torque introduced into a pedal crankshaft of a pedelec comprising:
determining wherein the rotational speed of the driven wheel;
determining the speed of the pedal crankshaft;
calculating an average deviation of the torque signal of the torque sensor relative to an average value; and
starting the calibration process when the rotational speed of the wheel is zero, the rotational speed of the treadle shaft is zero and the average deviation of the torque signal is below a predefined maximum value.
